(19) United States
(12) Patent Application Publication
(10) Pub. No.: US 2009/0084481 A1
(43) Pub. Date: Apr. 2, 2009

(54) TIRE INFLATION CONTROL METHOD AND APPARATUS

(76) Inventor: MICHAEL V. KALAVITZ, Plainwell, MI (US)

Correspondence Address: KANE & CO., PLC, 29 PEARL ST. NW, 410 FEDERAL SQUARE BUILDING, GRAND RAPIDS, MI, 49503, US

(21) Appl. No.: 11/865,221

(22) Filed: Oct. 1, 2007

(51) Int. Cl. B60C 23/10

(52) U.S. Cl. 152/417

(57) ABSTRACT

An apparatus and method are provided for controlling the air pressure within one or more tires on a vehicle. Means are provided for controlling air pressure dynamically or manually in response to road conditions. Instrumental in the invention is the ability to control the air pressure at each wheel from a remote location using positive control that substantially reduces the chance leaks anywhere else in the system would result in inadvertent flat tires.

### BACKGROUND OF THE INVENTION

1. Field of the Invention

This invention relates generally to tire pressure control devices, and more particularly to a tire pressure control system for inflating and deflating one or more tires on the vehicle from within the passenger compartment of the vehicle.

2. Description of the Related Art

Tire pressure control systems have been used in the past to control tire pressure on a vehicle in order to affect how the vehicle behaves or responds to road conditions. For example, tire pressure is most often adjusted in response to loads of transport vehicles. Tire pressure is also adjusted to change the size of the tire footprint depending upon the road surface. For example, tire pressure may be reduced to place more surface area of the tread in contact with loose aggregate such as sand, mud or dirt. Tire pressure may be increased to place less tread in contact with hard surfaces such as asphalt or concrete when the vehicle is traveling at higher speeds.

Early systems such as disclosed in U.S. Pat. No. 3,102,573 provided systems where the air lines are passed through non-rotating axles to a hub of the wheel. There, an air line connected the tire to the center of the hub to permit the passage of the air. A common air line for the wheels ran through a line to a control valve and through another line to a diaphragm. The control valve was provided with an opening to the atmosphere and was connected through additional lines with an air reservoir filled by a compressor. The early systems such as disclosed in the '573 patent used a complicated linkage system to open and close valves in response to air pressure within complimentary suspensions systems. When the vehicle was loaded more heavily, the air pressure within the pneumatic suspension system increased causing the diaphragms to move and increase the tire pressure. Other systems wherein air lines were provided through the non-rotating axles disclosed in U.S. Pat. Nos. 4,154,279 in the name of Tsuruta; 4,387,931 to Bland; 6,484,774 to Naedler; and 6,871,686 to Cobb.

Subsequent systems provided air lines separate and apart from the axles. These later developed systems provided hoses or tubing connected directly to the exterior hub of the vehicle through a union or similar coupling that may remain stationary while the attached wheel spins about the union axis. Examples of such systems are disclosed in U.S. Pat. Nos. 3,108,520 to Garis et al.; 3,718,200 and 4,598,750 to Gant; and 5,398,743 to Bartos

### SUMMARY OF THE INVENTION

According to one form of the invention, an apparatus is provided for controlling the tire pressure of a vehicle. The invention includes a housing having first and second ports, and a member journaled within the housing. The housing and the journaled member rotate with respect to one another. Depending on the specific design as described in more detail below, the housing or the journaled member may be driven. The journaled member includes a first and second passages formed therein which are in fluid communication with a source of pressurized air through a seal assembly disposed within the housing. A valve assembly is interconnected to the rotating member and is in fluid communication with the first and second passages formed in the rotating member. The valve assembly's function is for placing one of the first and second passages in fluid communication with a tire on the vehicle.

In another form of the invention, a control valve assembly is in fluid communication with the first and second ports of a non-rotating housing for controlling the flow of pressurized fluid between the first and second ports and the control valve assembly. In addition, a source of fluid under pressure is selectively placed in fluid communication with the control valve assembly. A user interface may be operably coupled to the control valve assembly to control a flow of the pressurized fluid to and from the first and second ports in the housing.

In accordance with yet another form of the invention, an apparatus is provided for controlling a flow of air to and from one or more tires on a vehicle. The invention includes an axle housing having a first and second fluid conduit extending transversely through a wall thereof. An axle having a first and second fluid passage formed therein may be journaled within the axle housing so that the axle may spin about its longitudinal axis. A seal assembly is disposed within the axle housing for directing fluid within the first fluid conduit to the first fluid passage though a first annular passage, and for directing fluid within the second fluid conduit to the second fluid passage through a second annular passage. A valve assembly is interconnected to the axle and placed in fluid communication with the first and second passages for placing a tire in fluid communication with one of the first and second passages. The value assembly includes a passage that is in fluid connection with the vehicle line. A further embodiment of the invention envisions a control valve assembly in fluid communication with the first and second ports of the housing for controlling the flow of a fluid between the first and second port and the control valve assembly. A source of fluid under pressure is further provided which is in fluid communication with the control valve assembly. A user interface may be operably coupled to the control valve assembly to control a flow of pressurized fluid to and from the first and second ports in the housing. It is further anticipated that the driven member may include one of an axle, a spindle, hub, or spindle housing.

According to yet another embodiment of the invention, an apparatus for controlling a flow of fluid to and from a vehicle tire is provided having a spindle housing having a first and second fluid conduits extending transversely through a wall thereof. A spindle having a first and second fluid passages formed therein is journaled within the spindle housing and received within the seals disposed within the spindle housing. The seals provide fluid within the first fluid conduit to the first fluid passage though a first annular passage, and provide fluid within the second fluid conduit to the second fluid passage through a second annular passage. A valve assembly is interconnected to the spindle and is in fluid communication with the first and second passages for adding or removing fluid from the tire in response to positive air pressure within one of the first and second conduits.

According to yet another embodiment of the invention, an apparatus for controlling a flow of fluid to and from a vehicle tire is provided having a hub containing a first and second fluid conduits extending transversely through a wall thereof. A spindle having a first and second fluid passages formed therein is journaled within the hub and received within seals disposed within the hub. The seals direct fluid within the first fluid conduit to the first fluid passage though a first annular passage, and for providing fluid within the second fluid conduit to the second fluid passage through a second annular passage. A valve assembly is interconnected to the hub and is in fluid communication with the first and second passages for adding or removing fluid from the tire in response to positive air pressure within one of the first and second conduits.

### BRIEF DESCRIPTION OF THE DRAWING FIGURES

FIG. 1 is a schematic illustration of one form of the invention;

FIG. 2 is a schematic illustration of another aspect of the invention shown in FIG. 1;

FIG. 3 is an exploded view of one embodiment of the invention shown in FIG. 2;

FIG. 4 is a cross-sectional view of the embodiment shown in FIG. 3;

FIG. 5 is an enlarged view of a portion of the invention shown in FIG. 4;

FIG. 6 is an exploded view of another embodiment of the invention shown in FIG. 2;

FIG. 7 is a cross-sectional view of the embodiment of the invention shown in FIG. 6;

FIG. 8 is an enlarged view of a portion of the invention shown in FIG. 7;

FIG. 9 is an exploded view of another embodiment of the invention shown in FIG. 2;

FIG. 10 is a cross-sectional view of the embodiment shown in FIG. 9; and

FIG. 11 is an enlarged view of a portion of the invention shown in FIG. 10.

### DETAILED DESCRIPTION OF THE DIFFERENT EMBODIMENTS

For purposes of the following description, the terms “upper,” “lower,” “right,” “left,” “rear,” “front,” “vertical,” “horizontal,” and derivatives and synonyms thereof shall relate to the invention as displayed in the respective figure referenced in that portion of the detailed description. However, it is to be understood that the invention may assume various alternative orientations, except where expressly specified to the contrary. It is also to be understood that the specific devices and processes illustrated in the attached drawings and described in the following specification are simply exemplary embodiments of the inventive concepts defined in the appended claims. Specific dimensions and other physical characteristics relating to the embodiments disclosed herein are not to be considered as limiting, unless the specification and claims expressly state otherwise.

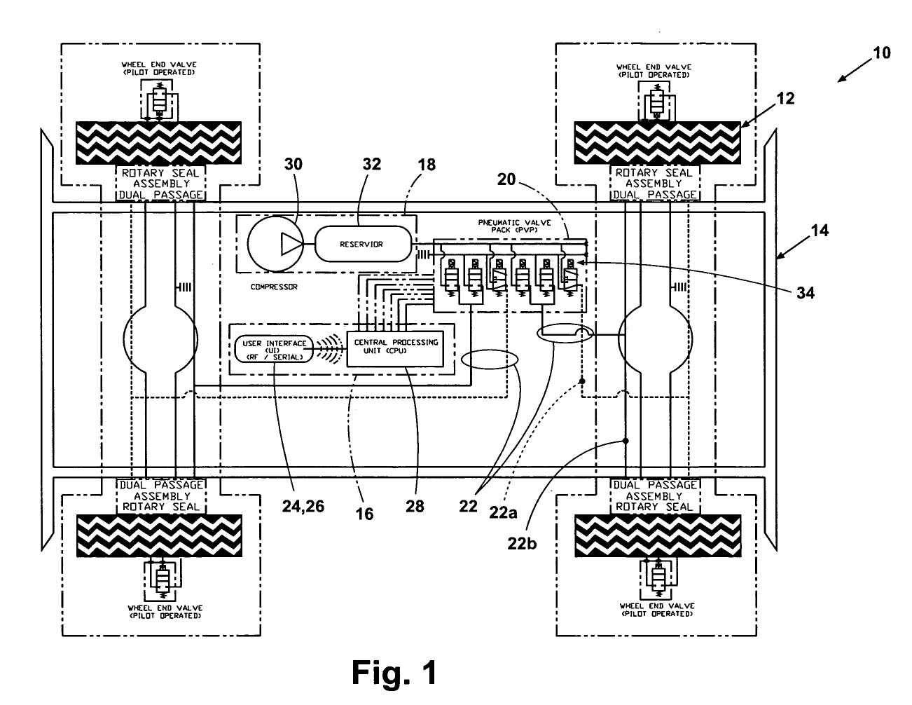

The reader can obtain a better understanding of the invention by reference to the drawing figures, and in particular to FIG. 1 wherein a schematic illustration of one form of the invention is shown. In its broadest sense the invention includes a system 10 for controlling the air pressure within each wheel 12 of a vehicle 14. In its most general form, the system 10 includes a user interface 16 typically mounted within the vehicle 14 for use by the operator in determining the air pressure within each vehicle wheel 12 and increasing or decreasing the air pressure within any wheel 12. The user interface 16 is operably coupled to other components of the system 10 including, but not limited to, a pressure source 18 and a distributor 20 interconnected to each of the wheels 12 by an array or plurality of fluid conduits 22. The user interface 16 may also be coupled to systems already used in the industry to monitor the amount of air pressure within each wheel as well as other vehicle sensing and diagnostic systems.

The user interface 16 may include a display 24 and a key pad 26 connected to a programmable logic control circuit or other central processing unit 28 for converting the user's input into commands, as well as converting output from the different system components into information readable on the display 24. The pressure source 18 may be comprised of a compressor 30 and a reservoir 32 coupled through a pressure line to the distributor 20. The compressor may include any one of a number of different types of compressors for providing the compressed air to the reservoir 32 including battery operated pumps as well as pumps operated by the vehicle engine or belt system (not shown). The distributor 20 distributes pressurized fluid from the pressure source 18 to conduits 22 through an array of valves 34. A first set of valves within the array 34 are in fluid communication with each wheel 12 or set of wheels through the conduits 22. A second set of valves within the array 34 are in fluid communication with a separate valve proximate each wheel or set of wheels 12 and described in greater detail below.

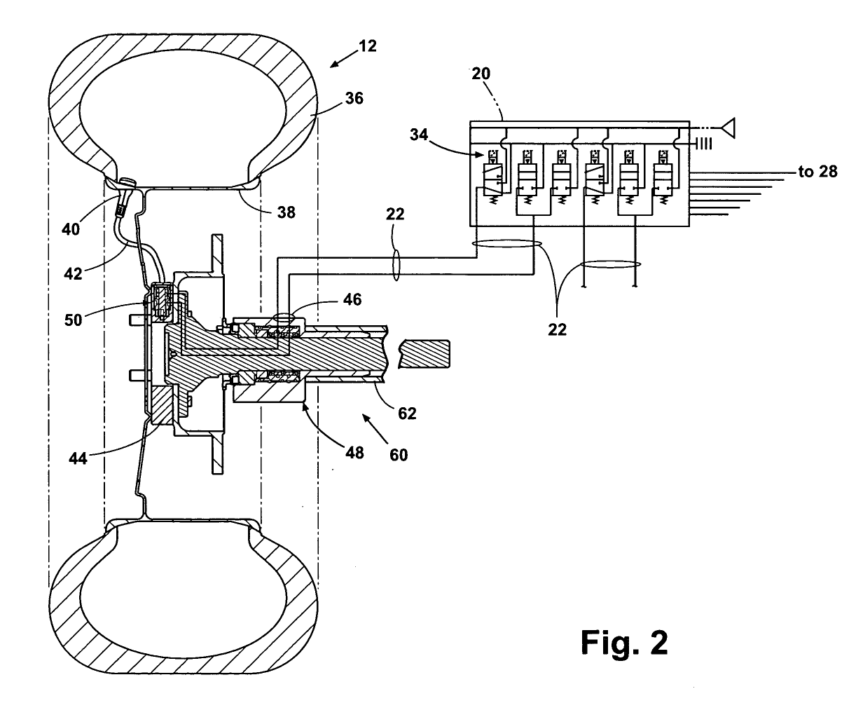

FIG. 2 is a schematic illustration of another aspect of the invention shown in FIG. 1, and in particular, a schematic of the invention at each wheel 12. Each wheel 12 includes a tire 36 mounted to a rim 38 containing a valve stem 40. Each wheel 12 is coupled from the valve stem 40 or appropriate adapters to the rim 38 by a conduit 42 to a valve body 44 which is in fluid communication with the distributor 20 through conduits 46 passing through the axle, axle housing, spindle, hub, or spindle housing 48 described in greater detail below. One of the conduits within the group 46 which may contain fluid under pressure is utilized for inflating or deflating the tire, while a second conduit within the group 46 may contain fluid under pressure for operating a valve assembly 50 to permit the passage of the air to or from the tire 36 by means of conduit 42.

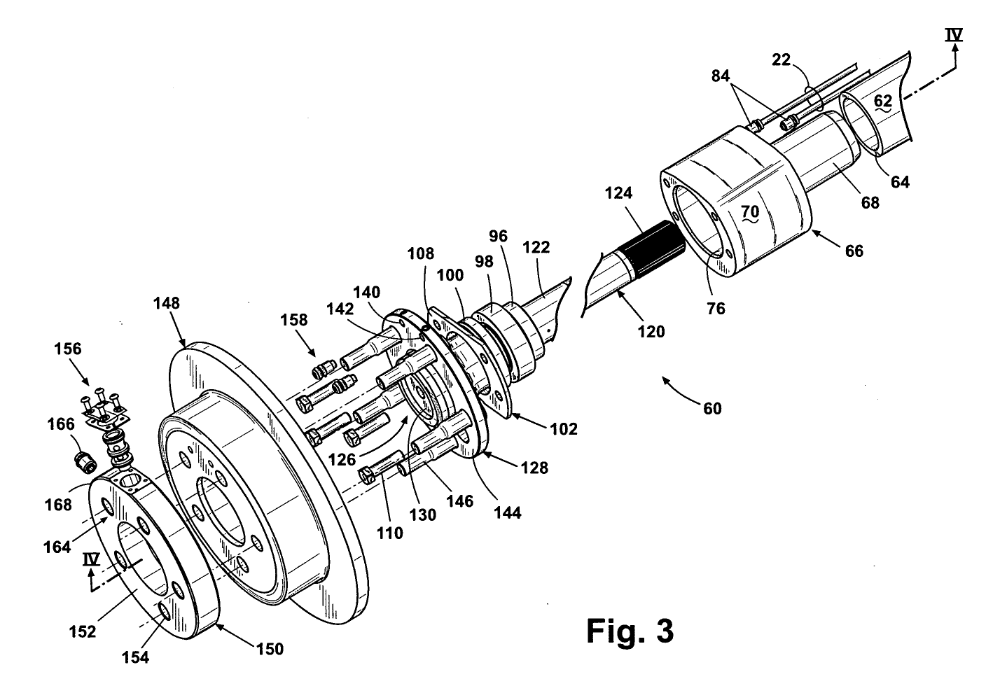

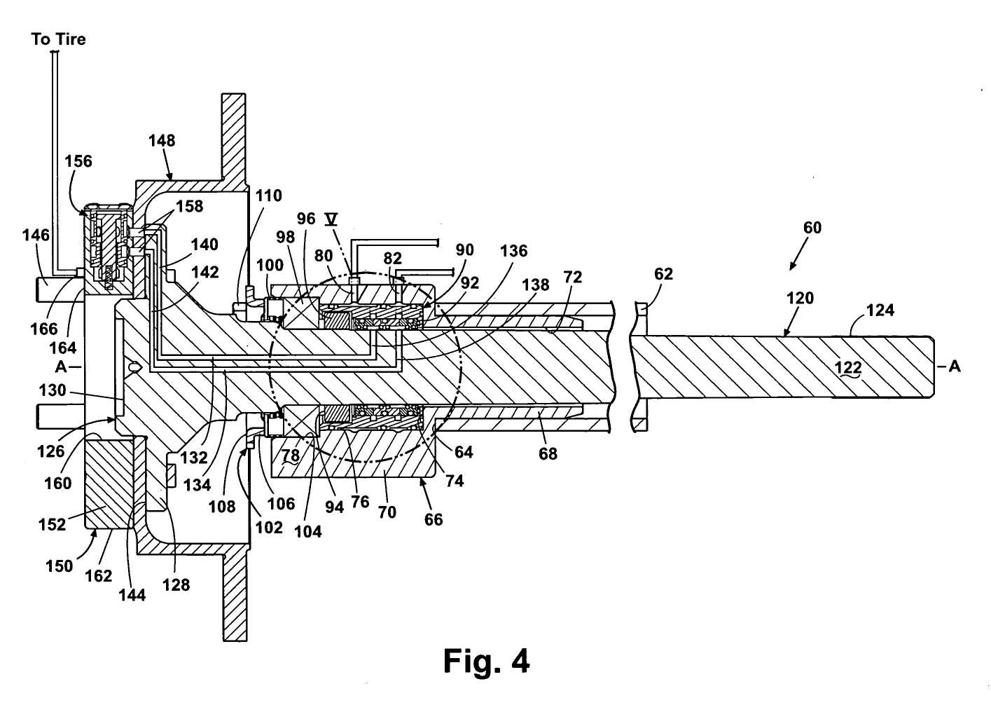

Referring to FIGS. 3 and 4, the first is an exploded view of one embodiment of the invention generally shown in FIG. 2 while the second is a cross-sectional view of the same structure taken along line IV-IV. This embodiment of the invention is best used on the rear drive or axle assembly wherein the wheels are not steered. For purposes of simplicity, the compete structure of the rear axle assembly will not be described as those of ordinary skill in the art should understand the interaction between each axle within the assembly and the differential gear assembly used to drive the axles.

As shown in FIGS. 3 and 4, each half of the axle assembly 60 includes an axle tube 62 or predetermined length extending from the differential gear housing located to the right and off the page of each figure. In this embodiment of the invention, the outboard ends 64 of each axle tube 62 is modified to receive an axle tube housing member 66 comprising a nipple or first end 68 received concentrically within the axle tube 62 and a second end 70 forming the terminus or end of the axle tube 62. The axle tube housing member 66 may be cast and or machined from the same type of material used to form the axle tube 62 although it is anticipated that other steel and aluminum alloys may be used if desired. In a preferred embodiment of the invention, the axle tube housing member 66 is fixed to the axle tube 62. In this embodiment the tube end 66 may be welded to the axle tube 62, but in the alternative the tube end may exist as part of the original equipment. It is anticipated that certain OEM designs may readily have a factory flange installed on the axle tube 62 and be utilized to “sandwich” the tube end 66 between it and the retainer plate 102 described below. It is further anticipated that one might not use the tube end 66 and instead use the factory tube and flange if it allows.

The axle tube housing member 66 includes a first concentric passage 72 (FIG. 4) extending from the first end 68 toward an intermediate shoulder 74 where the nipple or first end 68 makes a rather abrupt transition to the axle tube end or second end 70. A second larger-diameter concentric passage 76 is formed within the axle tube housing member 66 extends from the shoulder 74 out the second end 70. Extending transversely through a wall 78 of the axle tube end or second end 70 are a first and second ports 80 and 82, respectively, each in fluid communication with a respective one 22a, 22b of the plurality of conduits 22 described above. It is anticipated that a coupler 84 (FIG. 3) is received in the exterior end of each port 80, 82 to provide a fluid tight seal between a respective one 22a, 22b of the conduits 22 and each port 80, 82.

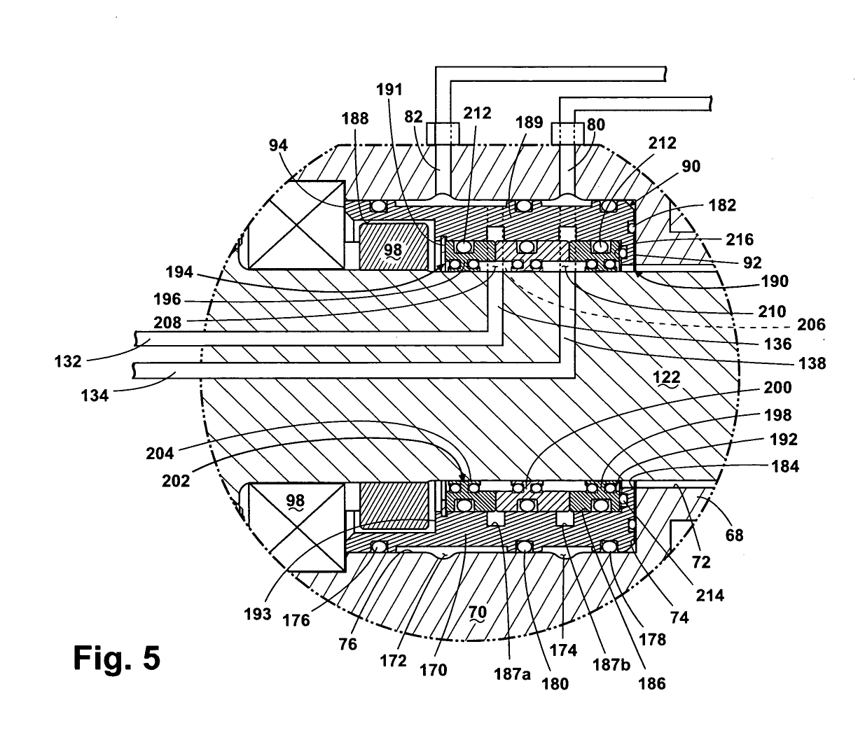

Received concentrically within the axle tube housing member 66 is a rotary seal assembly 90 (FIGS. 4 and 5) having a first end 92 urged against the shoulder 74 and extending a predetermined distance toward an intermediate portion of the axle tube end or second end 70. The second or opposite end 94 of the rotary seal assembly 90 is held in position by a concentrically received retainer ring 96 tapered roller bearing assembly 98, a dirt seal 100, and a retainer plate 102. The retainer ring 96 is urged against the tapered roller bearing assembly 98 in order to reduce any axial movement of the tapered roller bearing assembly 98. The tapered roller bearing assembly 98 and seal 100 are concentrically received within a third axial passage 104 formed in the axle tube end or second end 70 of the axle tube housing member 66 and outboard of the first and second passages 72 and 76 and held by a retainer plate 102. The retainer plate 102 may be in the form of an annular flange having a first leg 106 concentric with the third passage 104 and a second leg or flange 108 extending radially outward therefrom having a plurality of holes (not shown) for receiving bolts 110 received within threaded holes formed in the end of the second end 70 of axle tube end 66.

Extending from the axle tube housing member 66 and journaled by the tapered bearing assembly 98 is an axle 120 having an axle shaft 122 concentrically received within the axle tube 62, the rotary seal assembly 90, the bearing retainer ring 96, the tapered roller bearing assembly 98, the dirt seal 100, and the retainer plate 102 (See FIG. 4). The axle shaft includes a first splined end 124 received by the differential gear assembly mentioned earlier, and a second end 126 located outboard the axle tube housing member 66. As is conventional with axles of this form, one half of the tapered roller bearing assembly 98 is press fit along the axle shaft 122 and held tightly within the housing member 66 by the opposite half of the tapered roller bearing assembly 98, the dirt seal 100, and the retainer plate 102. The diameter of the shaft 122 increases as it transitions from the press fit tapered roller bearing assembly 98 to the axle end 126 where an axle flange 128 radially extends therefrom forming the largest diameter of the entire axle 120.

Extending inwardly from an outboard end 130 of the second end 126 into the shaft 122 in a direction parallel to a longitudinal axis A of the shaft 122 are a first and a second axial conduits 132 and 134, respectively. Each conduit 132, 134 is formed in each shaft 122 using a rifle boring technique or other acceptable means so that the integrity of each conduit or passage 132, 134 is maintained and separate and apart from one another. Extending radially inwardly from the exterior of the shaft 122 and intersecting a respective one of the conduits or passages 132, 134 are trans-axial shaft ports 136, 138, the outer ends of which open adjacent the rotary seal assembly described in greater detail below. Also intersecting each of the respective axial ports 132, 134 proximate the outboard end of the second end 126 are trans-axial flange ports 140, 142, the upper reaches of which extend through a front face 144 of the flange 128.

Extending perpendicularly through the axle flange 128 and out from the face 144 at a plurality of radially equidistant locations are lug studs 146. In one embodiment, immediately adjacent the face 144 of the axle flange 128 and received over the lug studs 146 may be a brake rotor/drum 148. Mounted outboard of the brake rotor/drum 148 and also received over the lug studs 146 is a valve body assembly 150 described in greater detail below.

Extending through the brake rotor/drum 148 and interconnecting each of the respective trans-axial flange ports 140, 142 with corresponding ports in the valve body assembly 150 are flange coupler fittings 158. Each flange coupler fitting 158 is essentially a tubular member having an axial passage extending there through which is adapted to provide a competent air passage from each trans-axial flange port 140, 142 to the valve body assembly 150. It is envisioned that the flange coupler fittings 158 may be permanently fixed to the axle flange 128 and fitted with an o-ring seal about the exterior of the end receiving the valve body assembly 150, for it is the purpose of each flange coupler fitting 158 to provide an air passage from the axle flange 128 to the valve body assembly 150. Anyone of a number of other structures may be used to provide that function without departing substantially from the intent of the invention.

In one embodiment of the invention, the valve body assembly 150 may generally be in the form of torus- or annulus-like body 152 having a plurality of equidistantly radially spaced holes 154 through which are received the lug studs 146. The valve body assembly 150 includes a valve assembly 156 therein which is in fluid communication with the trans-axial flange ports 140, 142 mentioned above through flange coupler fittings 158 extending from the face 144 of the flange 128, through the brake rotor/drum 148, and into the respective trans-axial flange ports 140, 142 terminating in the valve body assembly 150. Extending from one of an inner perimeter surface 160, an outer perimeter surface 162, or outboard face 164 is a fitting 166 (FIG. 3) received within a port 168 in valve body assembly 150 and also in fluid communication with the valve assembly 156. From fitting 166, a conduit 42 (FIG. 2) may be attached, the opposite end of which is attached to the valve stem 40 or appropriate fittings attached to the vehicle wheel 12. In a preferred embodiment of the invention, the valve assembly 156 may be a pilot operated valve wherein the pilot head of the valve may be in fluid communication with one of the conduits such as 22a, and the other portion of the pilot valve assembly 156 may selectively place the other of the conduits such as 22b in fluid communication with the fitting 166 and ultimately with the wheel 12.

Referring back to FIGS. 4 and 5, the rotary seal assembly 90 will be described in greater detail. As best seen in FIG. 5 the rotary seal assembly 90 includes a rotary seal gland or body 170 including two concentric outer annular channels 172, 174 intermediate the first end 92 and the second end 94, and each located opposite a respective port 80, 82 extending through wall 78 of the axle tube end member 70. Forming a seal with the intermediate passage 76, and separating each of the channels 172, 174 from one another and from a respective end 92, 94 of the rotary seal gland or carrier 170 are exterior seals 176, 178, and 180 received within a respective annular recess or channel formed in the exterior of the rotary seal gland or carrier 170. A forth exterior seal 182 is disposed in an annular channel formed in the end face 92 of the rotary seal gland or carrier 170 and adapted to seal against the shoulder 74 formed in the interior of the axle tube end housing 66.

The rotary seal gland or carrier 170 is substantially tubular to permit the axle shaft 122 to pass there through. The tubular passage extending longitudinally through the rotary seal gland 170 is formed by at least one and preferably two concentric interior tubular sidewalls 186, 188. Sidewall 186 may have a smaller diameter opening 190 in the end face 92 and terminate at an opposite end 192 forming the bottom of the first tubular sidewall 186. The first tubular sidewall 186 preferably extends longitudinally from end wall 192 up to face 193 where there is an abrupt change in diameter and there is a transition to tubular sidewalls 188. The second tubular sidewall 188 preferably extends from end wall 193 to the end 94. Concentric with the sidewall 186 and recessed relative thereto within the sidewall 186 are a first and second interior annular channel 187a, 187b, respectively. Each interior annular channel 187a, 187b is in fluid communication with a respective one of the outer annular channels 172, 174 by a plurality of transverse ports or passages 189 disposed radially between the interior and exterior annular channels 172, 174, 187a, 187b. Tubular sidewall 186 of seal gland 170 receives at least one rotary seal element assembly 194 described in greater detail below. Adjacent the rotary seal element assembly 194 and disposed within tubular sidewall 186 is snap ring 191 which restricts axial movement of rotary seal element assembly 194 with respect to the rotary seal gland 170. Disposed within the tubular sidewall 188 but not in contact with the tubular sidewall 188 is the bearing retainer ring 96 described above.

The rotary seal element assembly 194 briefly mentioned above functions to provide a fluid tight seal about the axle shaft 122 so that fluids within the axle differential do not escape. Simultaneously the rotary seal element assembly 194 also functions to provide a fluid tight seal between the respective interior annular channels 187a, 187b and a corresponding trans-axial port 136, 138 formed in the axle shaft 122. In a first embodiment, it is envisioned that rotary seal element assembly 194 may be formed as an integral member providing two outboard seal elements 196, 198 and an intermediate seal element 200. Although any suitable seal configuration may be acceptable to serve the intended purpose, it is desired that each seal element 196, 198 and 200 have a T-shaped or L-shaped lip(s) 202 in contact with the axle shaft 122 so that when pressurized, the pressurized fluid will force the respective cross members 204 of the lip(s) 202 into contact with the axle shaft 122. Ports 206 are radially disposed between each of the outboard seal elements 196, 198 and the intermediate seal element 200. Port 206 to provides fluid communication from each of the inner annular channels 187a, 187b to the annular chambers 208, 210 formed by the seal lips 202 of each outboard seal element 196, 198 and that portion of the intermediate seal element 200 surrounding that portion of the axle shaft 122 containing the trans-axial ports 136, 138. To prevent blow-by between the interior sidewall 186 and each of the rotary seal elements 196, 198, 200, o-ring seals such as generally identified by reference numeral 212 are disposed between each of the respective seal elements and the interior sidewall 186. An additional o-ring 214 is disposed between outboard seal element 198 and the interior end wall 216 formed by the end face 184.

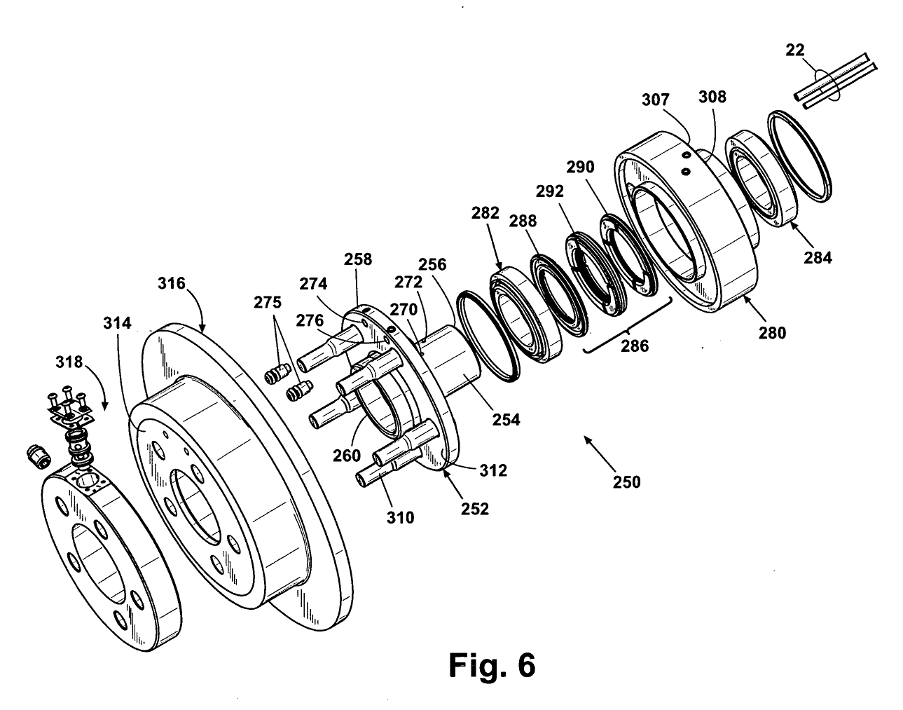

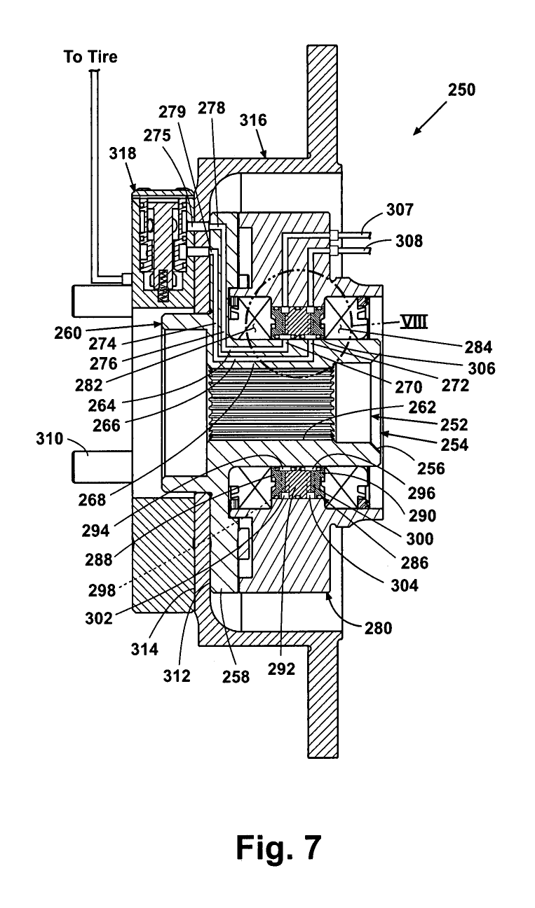

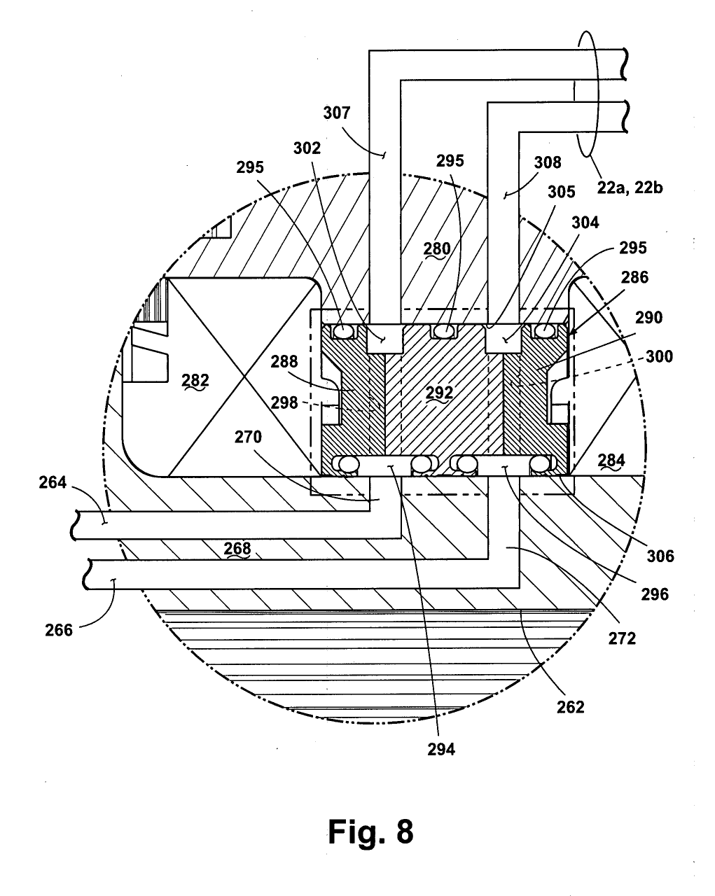

FIGS. 6 through 8 illustrate another embodiment of the invention wherein FIGS. 6 and 7 provide an exploded and cross-sectional view, and FIG. 8 provides an enlarged view of a portion of the invention shown in FIG. 7. Referring to the drawings, a hub assembly 250 is shown embodying one form of the invention. The hub assembly 250 includes a rotating spindle 252 having a concentric cylindrical main tube 254 having a first end 256 and a generally disk-shaped flange 258 proximate an opposite end 260 concentric with and arranged substantially perpendicularly to the axis of the main tubular body 254. The cylindrical main tube hub 254 preferably has internally splined inner wall 262 for receiving the splined end of a drive shaft (not shown) used to turn the spindle 252. In this embodiment of the invention, two longitudinal passages or ports 264, 266 are formed within the cylindrical tubular body wall 268 substantially parallel to one another and spaced from one another. Both passages 264, 266 are intersected at a first end by a respective first and second trans-axial ports 270, 272 and at a second end by respective trans-axial flange ports 274, 276. Thus a fluid entering trans-axial port 270 flows through passage 264 and out through trans-axial flange port 276. Likewise, fluid entering trans-axial port 272 passes through longitudinal port 266 and out from trans-axial flange port 274. Disposed concentrically about the cylindrical main tube 254 of the spindle 252 is a spindle housing 280. Housing 280 is non-rotating and may be fixed by most users to what is known as a “knuckle” supported by upper and lower A-frames, U-frames, wishbones or struts (not shown). But, in other designs where the spindle is fixed and not rotating and the housing is rotating, it might be mounted in a different manner. Such a case is where a non-rotating spindle and rotating hub assembly on a vehicle rear axle is mounted to the axle tube end without a steering knuckle.

As shown in FIG. 7, the housing 280 journals the main tube 254 of the spindle 252 therein by a first and second tapered roller bearing assemblies 282, 284, respectively. Intermediate the tapered roller bearing assembly 282, 284 is a rotary seal assembly 286 having at least one sealing element. Intermediate the tapered roller bearing assemblies 282, 284 and an interior wall 306 is a first and second outboard seal element 288, 290 and an intermediate seal element 292 (See FIG. 8). It should be noted that rotary seal assembly 286 could have one total seal element that could replace first and second outboard seal elements 288, 290 and intermediate seal element 292. Together the three seal elements form two annular chambers 294, 296 immediately adjacent those annular regions of the main tube 254 containing the trans-axial ports 270, 272. The rotary seal assembly 286 also contains at least one, and preferably a plurality of equidistantly spaced radially extending passages 298, 300 passing between a respective outboard seal element such as 288, 290 and the intermediate seal element 292. The upper reaches of each radial passage 298, 300 terminate in one of two inner annular channels 302, 304 formed about the outer diameter of each seal 288, 290 and 292. In a preferred embodiment of the invention, the chambers 302, 304 may also be formed by shoulders present on each of the seal elements 288, 290 and 292 rather than machining the interior walls 306 or housing 280. To prevent blow-by between the interior sidewall 305 of the housing 280 and each of the rotary seal elements 288, 290, 292, o-ring seals such as generally identified by reference numeral 295 are disposed between each of the respective seal elements and the interior sidewall 305. Each of the channels 302, 304 are in turn in fluid communication with a respective one of the conduits 22a, 22b described above through ports 307, 308 passing through the housing 280. Thus, as air is passed through any one of the ports 307, 308, the fluid continues to travel into interior channels 302, 304, through passages 298 and 300, and the surrounding annular chambers 294, 296 and into the respective trans-axial ports 270, 272 described earlier. Due to the radial distribution of passages formed in the rotary seal assembly 286 as well as the annular chambers 294, 296, fluid may pass through the passages formed in the spindle 252 when the spindle is stationary or spinning within the spindle housing 280.

Referring again to FIGS. 6 and 7 passing transversely through the spindle flange 258 at equidistantly spaced locations are a plurality of lug studs 310 such that a threaded portion of each lug stud 310 extends substantially perpendicularly from a front face 312 of the spindle flange 258. Received over the lug studs 310 and juxtaposed to the front face 312 of the spindle flange 258 is a wall 314 of a brake rotor/drum 316. Adjacent and outboard of rotor wall 314 is a valve body assembly 318. The valve body assembly 318 is substantially identical to that described above and shown in FIGS. 3 and 4, and in fluid communication with the trans-axial flange ports 278, 279 by means of flange coupler fittings 275 in substantially an identical manner as that described above.

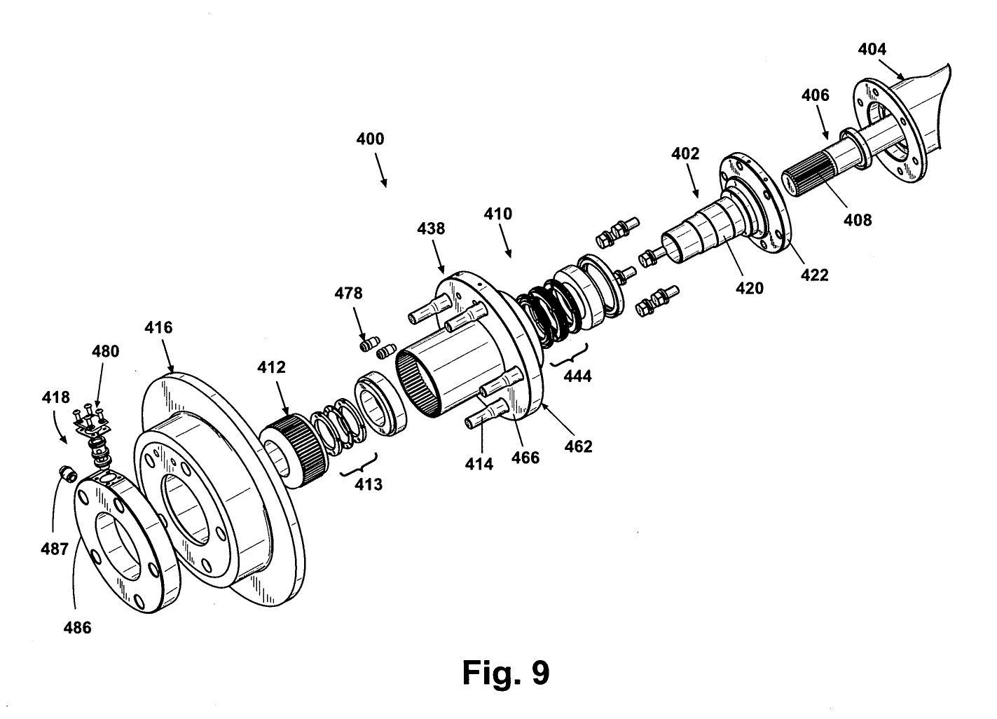

The invention described above has been made with specific reference to two rather common designs used today in vehicles. However the invention may be equally applicable to all terrain vehicle designs very much still on the road today and which use locking hub designs. In particular, the wheel design referenced is shown quite generally in FIGS. 9 through 11. In a locking hub design 400 shown in the drawing figures, a non-rotating spindle assembly 402 is attached to one of an axle tube or a knuckle 404 depending upon whether the wheel 400 is steerable or not. In cases of lockable hubs, the non-rotating spindle 402 is attached to an axle tube or moveable knuckle 404, and has an axle shaft 406 extending there through and received concentrically within the non-rotating spindle 402. The end of the axle shaft 406 extends completely through the non-rotating spindle 402 such that a splined end 408 of the shaft 406 extends well into a rotating hub assembly 410. The rotating hub assembly 410 includes among other things a hub lock assembly 412 received in an opposite end of the hub 410 which is designed to selectively place the splined end 408 of the axle shaft 406 in and out of locking relationship with the interior of the hub assembly 410 so that the wheel can either free-wheel about the non-rotating spindle 402, or be driven by the axle shaft 406. The hub assembly 410 also includes lug studs 414 over which are received the brake disk/drum 416, a valve body assembly 418, and ultimately the wheel as described above.

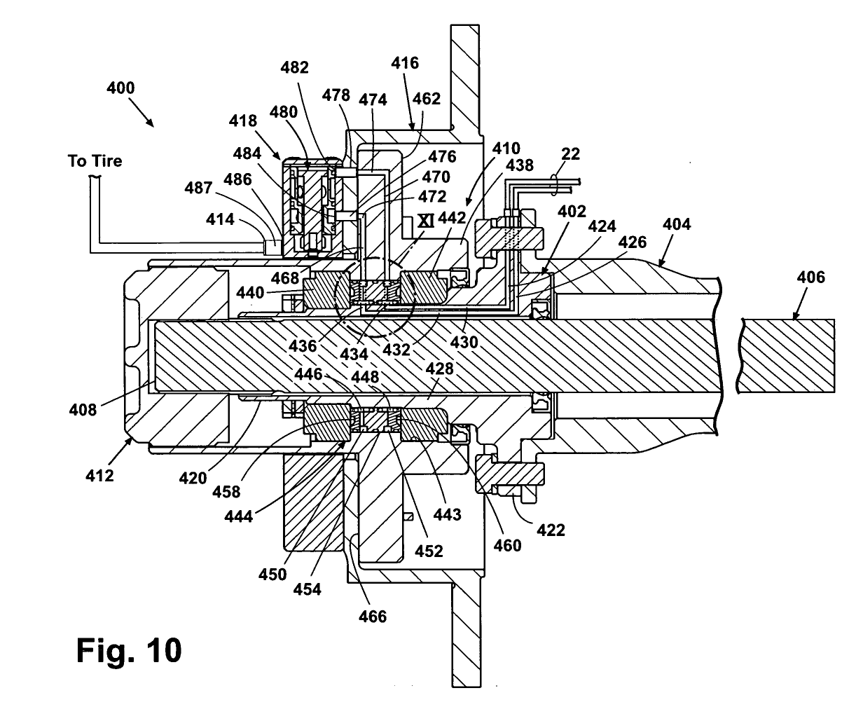

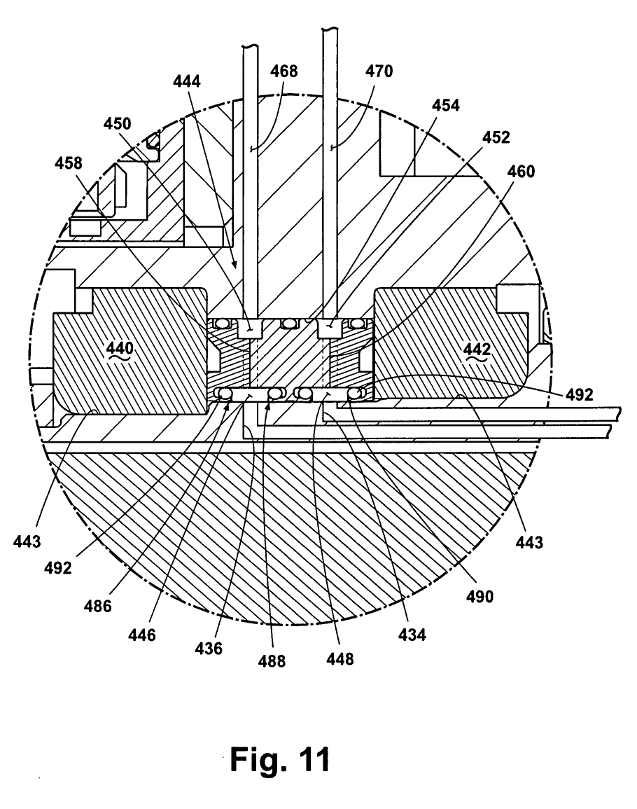

In this form of the invention shown in FIGS. 9 and 10, the non-rotating spindle assembly 402 includes a tubular member 420 having a stepped exterior cylindrical wall adapted to receive bearings and other seal members as described in greater detail below as well as hardware 413 for keeping the hub assembly 410 on the spindle assembly 402. At one end of the tubular member 420 the spindle includes a spindle flange 422 which provides the main connecting structural member for attaching the spindle 402 to the knuckle or axle tube 404 described above. Extending inwardly through any one of a number of different positions along the spindle flange 422 are at least two ports or passages 424, 426, each to be coupled to a respective one of the two conduits 22 extending from the distributor 20 discussed above. (FIG. 10) Each port or passage 424, 426 in turn is in fluid communication with a respective axial passage 430, 432 extending within a wall 428 forming the tubular member 420. At a predetermined point along the tubular member 428, trans-axial ports 434, 436 respectively, intersect a respective one of the axial passages 430, 432. See FIGS. 10 and 11.

Referring to FIG. 10, mounted on the tubular member 420 of the non-rotating spindle 402 is the hub assembly 410. The hub assembly 410 includes a rotating hub member 438 received concentrically about the tubular member 420 and supported on the spindle tubular member 420 by left and right tapered bearing assemblies 440, 442 disposed within axial bore 443, permitting the hub member 438 to rotate about the spindle 402. Intermediate the tapered bearings 440, 442 is rotary seal assembly 444. The rotary seal assembly 444, best shown in FIG. 11, defines two annular chambers 446, 448 immediately adjacent or about the tubular member 420 of the spindle 402 in an area circumscribing a respective trans-axial passage or port 434, 436 extending into the spindle tubular member 420. The rotary seal assembly 444 also includes two outer annular chambers 450, 452 defined between the rotary seal assembly 444 and an inner wall 454 of the rotating hub member 438. Passages 458, 460, respectively, extending radially outward within the rotary seal assembly, place inner chambers 446, 448 in fluid communication with out chambers 450, 452.

The rotating hub member 438 provides the primary structure for mounting the wheel to the vehicle, and includes a hub flange 462 which includes a plurality of lug studs 414 extending there through and substantially perpendicularly to a flange face 466. The lug studs 414 may receive the brake rotor/drum 416 and the valve body assembly 418 briefly described above, and ultimately the wheel 12 of the vehicle. The rotating hub member 438 includes a plurality of internal passages, including, but not limited to, a first and second trans-axial flange passage 468, 470, each extending radially outwardly beginning in the hub bore 454 immediately outboard of a respective outer annular chamber 450, 452. At their upper reaches, each trans-axial flange passage intersects a flange port 472, 474 terminating in the face of the flange 466.

Received within each of the flange ports 472, 474 is one end of a plurality of flange coupler fittings 478. Each flange coupler fitting 478 extends from the face 466 of the hub flange 462 through that portion of the brake rotor/drum 416 with the opposite end of each terminating in the valve body 418. Each flange coupler fitting 478 is essentially a tubular member having an axial passage extending there through which is adapted to provide a competent air passage from each trans-axial flange port 472, 474 to the valve body assembly 418. It is envisioned that the flange coupler fittings 478 may be permanently fixed to the hub flange 462 and fitted with an o-ring seal about the exterior of the end receiving the valve body assembly 418, for it is the purpose of each flange coupler fitting 478 to provide an air passage from the hub flange 462 to the valve body assembly 418. Anyone of a number of other structures may be used to provide that function without departing substantially from the intent of the invention.

As schematically illustrated in FIG. 10, the valve body includes a valve assembly generally indicated by reference numeral 480. The valve assembly is preferably a poppet-type valve wherein an upper end of the valve assembly is in fluid communication with a first passage 482 extending through the body 418 and in fluid communication with one of the passages provided by the conduits 472, 474 through flange coupler fittings 478. An intermediate portion of the poppet-type valve assembly 480 is in fluid communication with a second passage 484 extending through the valve body and communicating with an opposite one of the conduits 472, 474 through flange coupler fittings 478. The poppet-type valve assembly 480 is also in fluid communication with an outlet port 486 exiting the valve body. The outlet port 486 is preferably coupled with a fitting 487 that in turn is in fluid communication with the bladder of the tire mounted to the wheel rim. The purpose of the poppet-type valve assembly 480 is to control the flow of air across the valve assembly 480 to and from the tire air bladder or chamber and ultimately control the tire pressure. It should also be noted that the pilot operated poppet valve assembly 480 can provide for a positive isolation of the vehicle wheel tire pressure from the balance of the system.

The structural relationship of the components described above allow the user to supply a pressurized fluid from a remote source through the stationary components across a special sealed environment to a rotating or spinning set of components to control the amount of air pressure in each tire on the vehicle. The rotary seal assembly described above is one of many important aspects of the invention provided to achieve that purpose. Referring again to FIG. 10, the rotary seal assembly 444 is preferably mounted so that it rotates with the hub member 438. That portion of the seal assembly 444 engaging the non-rotating spindle tube member 420 includes a plurality of surfaces engaging the tubular member 420. In one embodiment, it is anticipated that each annular chamber 446, 448 is formed by a first and second sealing member. For example, annular chamber 446 is formed by a first lip seal 487 on one side and a second lip seal 488 on an opposite side. Each lip seal such as 487, 488, and 490 includes a tab or lip urged against the tubular member 420 by a biasing member 492. The sealing force of each lip seal against the tubular member 420 is increased when each chamber 446, 448 is under pressure. As pressure is greater along the back of each lip seal than on the face against the tubular members, a good competent seal if formed in dynamic position between static and rotary components.

We have described above three different structural situations where the instant invention has application. Each environment provides a substantially enclosed system where the conduits are concealed or removed from the harsh environment through which vehicle axles, wheels and tires are exposed to everyday. In substantially every situation, the invention provides an effective and novel approach to providing protected conduits supplying pressurized fluid through static structures to a spinning structure while maintaining the integrity and competency of the fluid passages to provide constant and dependable pressurized fluid to and from the tire while simultaneously reducing the chance that air will leak from the tire as a result in a breakdown of any of the fluid passages. This is achieved by placing positive control over the flow of pressurized fluid to and from the tire proximate the tire via the pilot operated poppet valves rather than upstream in the system. Because each of the systems described above are structurally different in many respects, the operation of the invention will make general reference to the different structures described above, and it should become readily apparent to one of ordinary skill in the art how the function of one structure in one embodiment has a corollary component in another embodiment.

In operation, pressurized fluid may be provided to or taken from the tire on the wheel 12 through a predetermined command input by the user through the user interface 16. According to a predetermined logic programmed into the user interface 16, central processing unit or programmable logic control 28, appropriate signals are sent to one or more actuators within the distributor 20 when the user issues a command from the user interface 16. This in turn causes one or more of the valves within the valve array 34 to shift allowing fluid pressure in one of the two conduits 22a, 22b to actuate or shift the pilot valve 156. This permits the actual tire pressure at the wheel 12 to be communicated back through the pilot valve 156 and the other of the two conduits 22a, 22b to the central processing unit 28 for evaluation. Should the air pressure at wheel 12 need to be increased as a result of comparing the actual fluid pressure at wheel 12 with the user required results as input at the user interface 16, appropriate signals are sent to one or more actuators within the distributor 20 allowing for pressurized fluid within the pressure source 18 into one or both conduits 22a, 22b. The pressurized fluid within one conduit of the conduits 22a, 22b actuates or keeps shifted the pilot valve within the respective valve assembly 156 which in turn permits pressurized fluid from the pressure source 18 and within the other of the conduits 22a, 22b to pass through the pilot valve 156 into the tire on the wheel 12. In this manner, pressurized fluid in the form of pressurized air cannot be added to the tire on the wheel 12 without actuation of the pilot valve within the valve assembly 156 at each wheel. The central processing unit or programmable logic controller 28 continues to monitor the actual fluid pressure at wheel 12 and issue the appropriate commands to the actuators in distributor 20 until the users required results are obtained as input at the user interface 16. Once the required result at wheel 12 is obtained, the pressure conduits 22a and 22b are exhausted allowing the pilot valve assembly 156 to shift to its normal position via a biasing force. This permits for the full isolation of the fluid pressure in wheel 12 from the balance of the upstream components. Should the air pressure at wheel 12 need to be decreased as a result of comparing the actual fluid pressure at wheel 12 with the user required results as input at the user interface 16, appropriate signals are sent causing one or more actuators within the distributor 20 to move only those valves providing the pressurized fluid from the pressure source 18 to actuate or keep shifted the pilot valve within the respective valve assembly 156. This allows for the pressurized air within the wheel 12 to pass through valve assembly 156, through the relevant conduit 22a, 22b to a dump valve within the distributor 20 or elsewhere on the vehicle. The central processing unit or programmable logic controller 28 continues to monitor the actual fluid pressure at wheel 12 and issue the appropriate commands to the actuators in distributor 20 until the users required results are obtained as input at the user interface 16. Once the required result at wheel 12 is obtained, the pressure conduits 22a and 22b are exhausted allowing the pilot valve assembly 156 to shift to its normal position via a biasing force. This permits for the full isolation of the fluid pressure in wheel 12 from the balance of the upstream components.

An advantage of the different embodiments of the instant invention is that the air pressure within any one or more of the vehicle wheels 12 may be adjusted in response to road conditions dynamically. Conventional radio frequency systems may monitor tire pressure within each tire and provide that information to the cpu/plc 28 and then to the user interface 16. As the tire pressures within each tire exceeds predetermined limits set by the user, the tire pressure control system of this invention may add, release, or keep static the tire pressure. In addition, the user may over ride the limits set in the cpu/plc 28 and manually adjust the pressure on the fly. This is possible by the rotary seal assembly surrounding the axle shaft 122 or spindle 252 described above. The annular sealing arrangement surrounding the co-axial or substantially co-axial passages formed in the respective axle 122 or hub 252 permit the passage of pressurized fluid to the tire without the complex umbilical lines, hoses, and unions passing around the wheels and exposed to substantially devastating abuse and obstacles. Another advantage of the instant invention is the manner in which the ultimate control to add or release air to each respective wheel is disposed at each wheel, rather than further upstream of the wheel. By placing the positive control over the addition or reduction of air to the tire at each wheel, there are far fewer joints, connections, couplings and the like where leaks could occur, resulting in the unintentional release of air from the tire causing it to go flat.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents. The embodiments of the invention in which an exclusive property or privilege is claimed are defined below.

Having now described the features, discoveries and principles of the invention the manner in which the invention is constructed and operated, the characteristics of the invention, and the advantageous, new and useful results obtained; the new and useful structures, devices, elements, arrangements, parts and combinations are set forth in the appended claims.

The invention claimed is:

1. An apparatus for controlling the pressure of a vehicle tire, comprising: a stationary housing having a first and second ports; a driven member concentric with respect to said housing, said driven member including a first and second passages formed therein; a seal assembly disposed between said housing and said driven member for placing a respective one of said first and second ports of said housing in fluid communication with a respective one of said first and second passages within said driven member; and a valve assembly interconnected to said driven member and in fluid communication with said first and second passages for placing one of said first and second passages in fluid communication with a tire on the vehicle.

2. The apparatus as defined in claim 1, further comprising a control valve assembly in fluid communication with said first and second ports of said housing for controlling the flow of a fluid between said first and second port and said control valve assembly.

3. The apparatus as defined in claim 2, further comprising a source of fluid under pressure in fluid communication with said control valve assembly.

4. The apparatus as defined in claim 3, further comprising a user interface operably coupled to said control valve assembly for controlling a flow of pressurized fluid to and from said first and second ports in said housing.

5. The apparatus as defined in claim 1, wherein said driven member includes an axle.

6. The apparatus as defined in claim 1, wherein said driven member includes a spindle.

7. The apparatus as defined in claim 1, wherein said driven member includes a hub.

8. The apparatus as defined in claim 1, wherein said housing includes an axle tube.

9. The apparatus as defined in claim 1, wherein said housing includes a spindle housing.

10. The apparatus as defined in claim 1, wherein said housing includes a hub.

11. An apparatus for controlling a flow of fluid to and from a tire on a vehicle, comprising in combination an axle housing having a first and second fluid conduits extending through a wall thereof; an axle having a first and second fluid passages formed therein journaled within said axle housing; a seal assembly disposed within said axle housing for providing fluid within said first fluid conduit to said first fluid passage though a first annular passage, and for providing fluid within said second fluid conduit to said second fluid passage through a second annular passage; and a valve assembly interconnected to said axle and in fluid communication with said first and second passages for placing a tire in fluid communication with one of said first and second passages.

12. The apparatus as defined in claim 11, further comprising a control valve assembly in fluid communication with said first and second ports of said housing for controlling the flow of a fluid between said first and second port and said control valve assembly.

13. The apparatus as defined in claim 12, further comprising a source of fluid under pressure in fluid communication with said control valve assembly.

14. The apparatus as defined in claim 13, further comprising a user interface operably coupled to said control valve assembly for controlling a flow of pressurized fluid to and from said first and second ports in said housing.

15. The apparatus as defined in claim 11, wherein said driven member includes an axle.

16. The apparatus as defined in claim 11, wherein said driven member includes a spindle.

17. The apparatus as defined in claim 11, wherein said driven member includes a hub.

18. The apparatus as defined in claim 11, wherein said housing includes an axle tube.

19. The apparatus as defined in claim 11, wherein said housing includes a spindle housing.

20. The apparatus as defined in claim 1, wherein said housing includes a hub.

21. An apparatus for controlling a flow of fluid to and from a vehicle tire, comprising in combination a spindle housing having a first and second fluid conduits extending transversely through a wall thereof; a spindle having a first and second fluid passages formed therein journaled within said spindle housing; a seal assembly disposed within said spindle housing for providing fluid within said first fluid conduit to said first fluid passage though a first annular passage, and for providing fluid within said second fluid conduit to said second fluid passage through a second annular passage; and a valve assembly interconnected to said spindle and in fluid communication with said first and second passages for placing a tire in fluid communication with one of said first and second passages.
